(19) United States
(12) Patent Application Publication
(10) Pub. No.: US 2019/0295024 A1
(43) Pub. Date: Sep. 26, 2019

(54) GLOBAL WEB-BASED PEER-TO-PEER REVIEW PLATFORM

(71) Applicant: Kiran Dhotre, Round Rock, TX (US)

(72) Inventor: Kiran Dhotre, Round Rock, TX (US)

(21) Appl. No.: 15/926,230

(22) Filed: Mar. 20, 2018

(51) Int. Cl. G06Q 10/06; H04L 29/08

(52) U.S. Cl. CPC G06Q 10/06395; H04L 67/306

(57) ABSTRACT

Various embodiments of a web-based, peer-to-peer system are disclosed to enable a rating of a target user or evaluatee, with a rating of the target user's professional performance. An overall composite score is thus provided which may consist of a predetermined number of individual scores. Ratings may either be accepted or archived by the target user and may not be rejected.

### FIELD OF THE INVENTION

The invention generally relates to web-based, peer-to-peer review platform. More specifically, the invention relates a peer review platform that empowers users to share candid, unbiased reviews on peers without utilizing any of their current organizational systems and/or networks.

### DESCRIPTION OF THE RELATED ART

While web-based, peer-to-peer evaluation systems are known, the known systems do not do one or more of the following elements:

Allow an evaluator to create a proxy profile of an evaluatee, who is not a registered user of the evaluation platform, whereby the evaluator may leave feedback and/or rate the evaluatee, also known as a target user.

Allow creation of a proxy profile for an evaluatee, whereby the proxy profile is required to be validated and activated by the intended evaluatee before the evaluator's review will be accepted.

Require an evaluatee, or target user, to either accept or archive reviews from evaluators. Rejection of an evaluation is not permitted.

Accepting an evaluation results in a combining of individual evaluation scores in batches of a predetermined size or number with an update of the evaluatee or target user's composite evaluation score.

Not enabling an evaluatee or target user to determine how any given evaluation by an evaluator affected the composite evaluation score of the evaluatee or target user.

A target user's election to archive, rather than accept, an evaluation that may cause a negative impact on the overall composite evaluation score, thereby discouraging archiving and encouraging acceptance of evaluations.

The present invention overcomes these deficiencies and provides, inter alia, the above-referenced improvements.

### BRIEF SUMMARY OF THE INVENTION

Generally, a system is provided to enable an evaluation of a target user or evaluatee, with a rating of the target user's professional performance including but not limited to ratings on: leadership, team player, integrity, skills, attitude and endorsement. An overall composite score is thus provided which may consist of a predetermined number of individual scores. Selected embodiments of the system allow one or more of the at least the following elements.

An evaluator may create a proxy profile of an evaluatee, who is not a registered user of the evaluation program, whereby the evaluator may leave feedback and/or rate the target user.

The system may require an evaluatee, or target user, to either accept or archive evaluations from evaluators. Rejection of an evaluation in this embodiment is not permitted.

The system may, in certain embodiments, combine individual evaluation scores after an evaluation is accepted into batches of a predetermined size or number with an update of the evaluatee or target user's composite evaluation score.

The system disclosed here may, in certain embodiments, not enable an evaluatee or target to determine how any given evaluation by an evaluator affected the composite evaluation score of the evaluate or target. This is achieved through use of the predetermined number of scores, also known as a batch threshold.

In certain embodiments, the system may, upon a target user or evaluate decision to archive, rather than accept, an evaluation will result in a negative impact on the overall composite evaluation score, thereby discouraging archiving and encouraging acceptance of evaluations.

### BRIEF DESCRIPTION OF THE DRAWINGS

FIG. 1 is a flowchart depicting one portion of an embodiment of the present invention.

FIG. 2 is a flowchart depicting one portion of an embodiment of the present invention.

FIG. 3A is a flowchart depicting one portion of an embodiment of the present invention.

FIG. 3B is a flowchart depicting one portion of an embodiment of the present invention.

### DETAILED DESCRIPTION

While the invention is amenable to various modifications and alternative forms, specifics thereof are shown by way of example in the drawings and described in detail herein. It should be understood, however, that the intention is not to limit the invention to the particular embodiments described. On the contrary, the intention is to cover all modifications, equivalents, and alternatives falling within the spirit and scope of the invention.

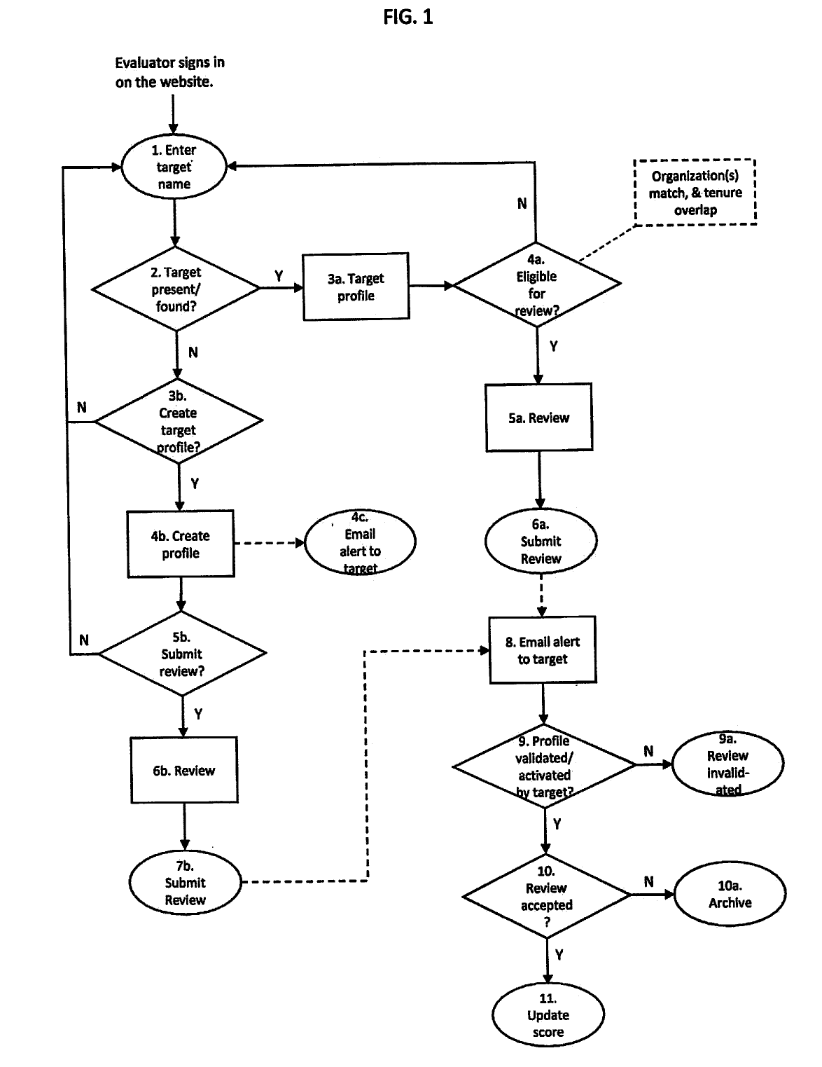

With reference to the FIGS. 1-3B, a global web-based peer-to-peer professional performance rating platform (PPRP) system is disclosed. Individuals evaluated under the PPRP are given an overall composite score, similar to a credit score, based on evaluations from peers who perform evaluations based on their work experience with the user. The score advantageously aids recruiters and job seekers in finding the desired job opportunities or the right associates. The PPRP facilitates peer review, in an unbiased manner.

The main users of the PPRP are evaluators (those providing the reviews/evaluations), target users (those receiving the reviews/evaluations) and the system for implementing the method (the server and application software). It is to be understood that evaluators may also become evaluatees and evaluatees may also become evaluators in the system. The PPRP facilitates peer-to-peer reviews by providing a system that generates or calculates and maintains a composite score for each user target. The PPRP provides a unique scoring mechanism that allows evaluators to create user profiles for targets advantageously preventing targets from hiding from the system. The PPRP permits evaluator users to evaluate a professional co-worker (a target user), only when the evaluator user's organization (company) and tenure are overlapping with the target user's organization and tenure.

The PPRP allows target users to view evaluations from evaluators by the name of the evaluator only, but does not allow viewing of the actual review rating, advantageously providing authenticity and confidentiality of the evaluator's rating of the target user.

The PPRP requires the target users to accept or archive evaluations from evaluators. Significantly, evaluations cannot be rejected by the evaluated target user. Accepting an evaluation will combine individual evaluation scores in batches and update the target's composite score, again, advantageously providing authenticity and confidentiality of the evaluator's rating of the target user, as the target users will not be able to determine how any evaluator affected the composite score. It is an important element of certain embodiments of the present invention that the composite score is confidential and displayed only to the owner of the profile.

Evaluation batches are the size of a “batch threshold”, combined with the current composite score, thus resulting in a new composite score. Archiving more than one, or a plurality of, reviews will negatively impact the resulting new composite score, advantageously discouraging targets from archiving peer evaluations and encouraging targets to accept peer evaluations. Unarchiving an archived evaluation may in some embodiments and in some cases positively impact the resulting new composite score, reversing the effect of archiving.

Thus, certain embodiments of the PPRP system may comprise one or more of the following:

An overall composite score is created and provided for a target user which may consist of a predetermined number of individual scores. Selected embodiments of the system allow one or more of the at least the following elements.

An evaluator may create a proxy profile of an evaluatee, who is not a registered user of the evaluation program, whereby the evaluator may leave feedback and/or rate the target user.

The system may require an evaluatee, or target user, to either accept or archive evaluations from evaluators. Rejection of an evaluation in this embodiment is not permitted.

The system may, in certain embodiments, combine individual evaluation scores after an evaluation is accepted into batches of a predetermined size or number with an update of the evaluatee or target user's composite evaluation score.

The system disclosed here may, in certain embodiments, not enable an evaluatee or target to determine how any given evaluation by an evaluator affected the composite evaluation score of the evaluate or target.

In certain embodiments, the system may, upon a target user or evaluate decision to archive, rather than accept, an evaluation will result in a negative impact on the overall composite evaluation score, thereby discouraging archiving and encouraging acceptance of evaluations.

Generally, the negative impact of archived reviews may proceed as follows.

1. Calculate the Ratio of number of reviews archived vs the number of reviews accepted (“RT”).

The RT is calculated by dividing the number of archived reviews by the number of accepted reviews.

2. Calculate the Penalty Factor (“PF”)

A penalty factor of, for example and without limitation, 0.05, may be established and may be multiplied by the ratio of number of archived reviews vs number of accepted reviews calculated in number 1 above.

3. Penalty Multiplier Threshold (“PMT”)

The PMT is based on the calculated ratio of archived reviews vs accepted reviews and may be preferably set or fixed at 0.5, though other PMT settings may be implemented as the skilled artisan will understand. If the calculated RT is greater than the PMT, e.g., 0.5, then the PF is amplified by multiplication with a Penalty Multiplier (“PM”) discussed below. This amplification of the PF with the PMT provides a greater impact on the composite score. Thus, the more reviews archived by the user, the greater the negative impact on the user's composite score.

4. Penalty Multiplier (“PM”)

The PM may preferably be fixed or set to a value of 40, though other PM values may also be used as will be readily apparent to the skilled artisan. The PM will be applied to all profiles with a calculated RT value that is great than the exemplary PMT of 0.5.

### Working Example 1

A profile has 8 accepted reviews and 4 archived reviews, so that the ratio of archived-to-accepted reviews (RT) calculated to be (8/4)=0.5. The exemplary penalty factor (PF) is set at 0.05 and the penalty multiplier threshold (PMT) is set at 0.5.

In this case, the RT is calculated to be 0.5. Thus, the PF is applied, but the penalty multiplier threshold (PMT) is not applied, since the RT equals, but is not greater than, the PMT. Therefore, then negative impact of the 4 archived reviews is calculated as follows: (RT×PF)=negative impact factor, or (0.5×0.05)=0.025.

A representation of the 0.025 negative impact factor on a composite score of 400 would be: 400*(1−0.025)=390.

### Working Example 2

However, if a profile has 8 accepted reviews and 5 archived reviews, the RT is calculated to be (8/5)=0.625, which exceeds the established, and exemplary, PMT of 0.5, so that the penalty multiplier (PM) is applied to obtain an amplification factor (“AF”) for the negative impact of archived reviews.

Accordingly, ((RT−PMT)×PM) or ((0.625−0.5)×40)=5. The AF is thus calculated to be 5 in this case.

Then, the negative impact of the archived reviews where RT exceeds PMT is calculated as follows: (AF×RT×PMT), or (5×0.625×0.05)=0.156.

A representation of the 0.156 negative impact factor on a composite score of 400 would be: 400*(1−0.156)=338.

Comparing the results from Working Examples 1 and 2, the case where the PM is not applied results in a negative impact factor of 0.025 and the case in which the PM is applied results in a negative impact factor of 0.156. Accordingly, the negative impact of archived reviews is greater when the RT exceeds PMT.

Turning now to FIG. 1, covering one embodiment of the PPRP system dealing with initial sign-in of the evaluator and entry of the target person to be evaluated and beginning at step 1. If the target person already has a profile in the PPRP system, the process allows the evaluator to create a review and submit it to the system at steps 2-6a. The PPRP system may search for both an individual target user's name and/or the target user's organization as well as an overlap in tenure at any of the target user's organizations with the evaluator's organizations. If there is no overlap in either organization or tenure, the system may send a message to the evaluator indicating that an evaluation is not possible.

If there are more than one profile with the same first and last names, the present invention allows the evaluator to select the intended profile by way of identifying the profile picture of the intended evaluatee and/or photo of the organization. If the evaluator is not satisfied that the intended evaluatee is positively identified in the list of potential evaluatees provided by the system, then the evaluator may proceed with creation of a proxy profile for the intended evaluatee.

An evaluator's review eligibility for the intended evaluatee is not determined during the search or within the search results. Once the evaluator selects the intended evaluatee from the list of potential evaluatees provided by the system, then if the evaluator is eligible to provide a review for the selected individual, a “Review” action button is provided next to the evaluatee's profile. If the evaluator is not eligible to review the intended evaluatee, then the “Review” action button is not provided and no message is sent.

At this point, the PPRP system automatically sends an email to the evaluated target at step 8 and determines whether the existing target user profile has been validated or activated by the target at step 9. If not, then the review is invalidated at step 9a. If the target user profile has been validated or activated by the target, then the target user must decide whether to accept or archive the evaluation at steps 10 and 10a, respectively. If the target user decides to accept the review, then the target user's score is updated at step 11.

Returning now to step 2, if the target user does not exist in the PPRP system, the evaluator may create a proxy profile, with notice to the target user at steps 3b, 4b and 4c. If the evaluator decides to create a proxy profile and submit a review at step 5b, the process continues as above with the creation of the review at step 6b, submission of the review at step 7b, with email alert to the target and subsequent steps at steps 8-11 as discussed above.

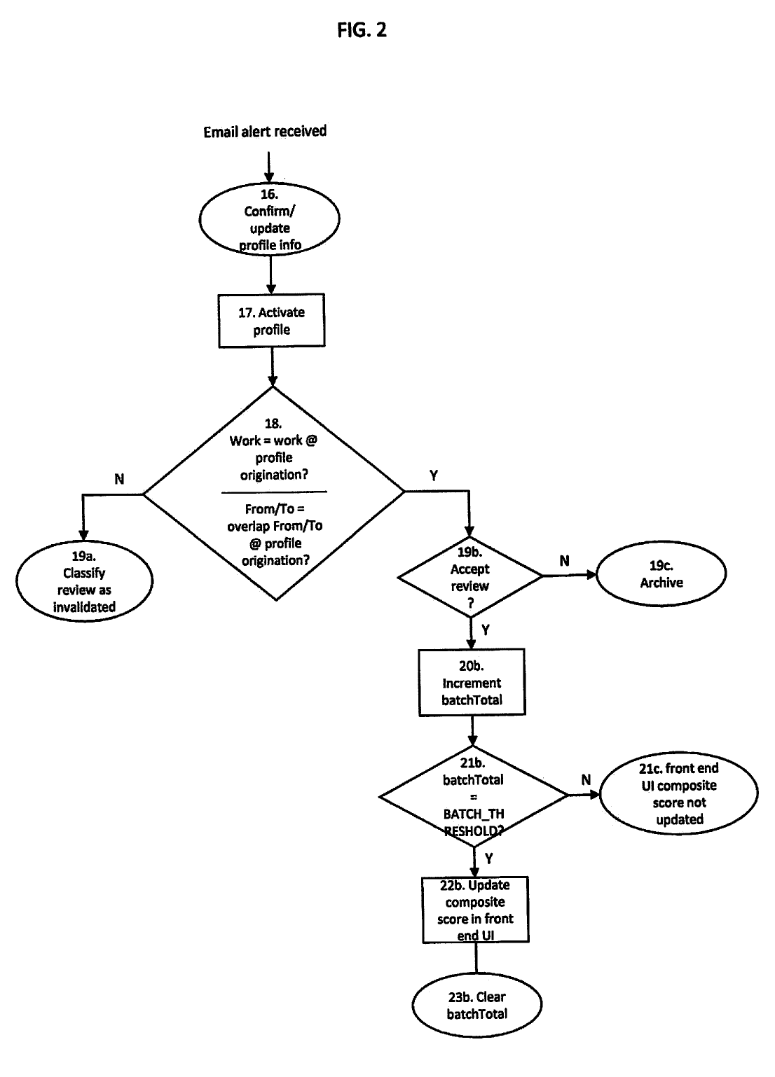

Turning now to FIG. 2, an exemplary process flow for review of a proxy profile as discussed in FIG. 1 above is provided. Thus, when the email alert in step 8 of FIG. 1 is received by the target user, the target user may at steps 16 and 17 review the proxy profile created by the evaluator, confirm the information is correct and/or update same and finally activate the profile. Once the profile is activated by the target user, the target user faces the decision in steps 19b and 19c to either accept the review or archive the review.

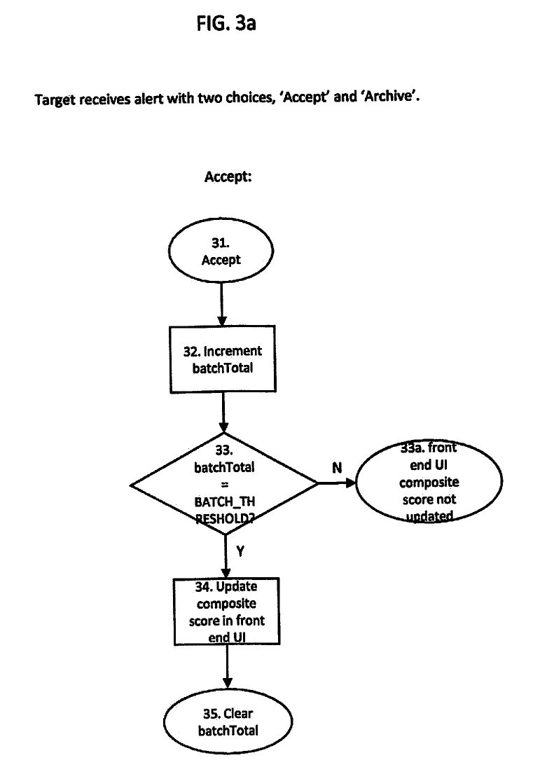

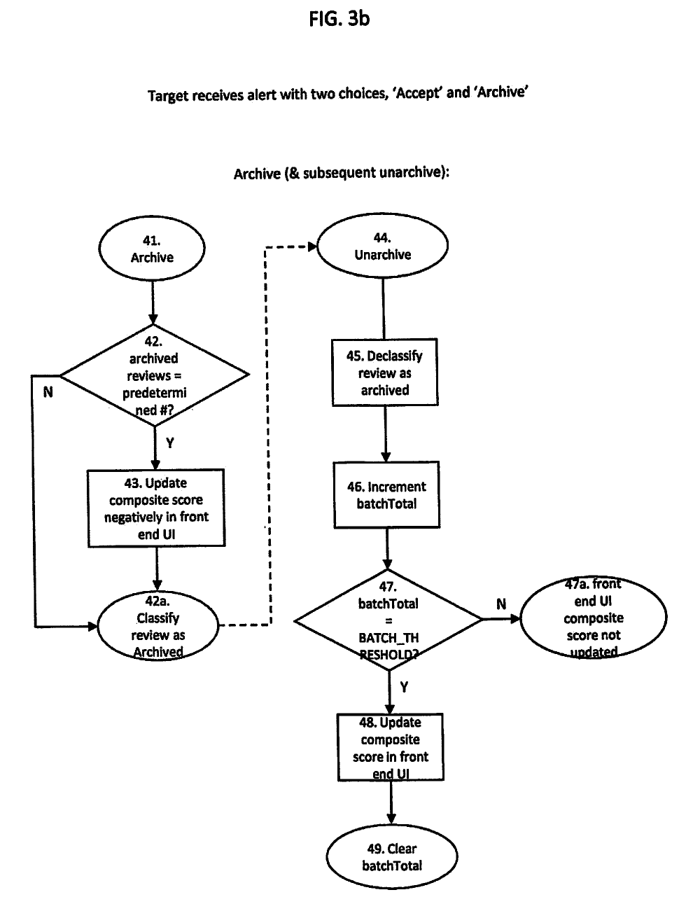

As seen in FIG. 2 at steps 19b, 20b, 21b, 21c, 22h and 23b and in FIG. 3a, acceptance of the review results in an update to the next incremental batch of scores and an update in the PPRP system of the overall composite score, which is not viewable to any user, evaluator or target, until the predetermined number of scores, or a batch threshold, is received. When the predetermined number of scores defining a batch are received, the updated composite score becomes visible.

If, on the other hand, a target user elects to archive the evaluation, see step 19c in FIG. 2, the exemplary process of FIG. 3b is executed, beginning with step 41. As seen, step 43 results in a negative effect on the overall composite score for an archived evaluation. Once classified as archived at step 42a, the target user may, however, unarchive the previously archived review at step 44. In that case, the PPRP system may reclassify the archived evaluation as non-archived and accepted with subsequent recalculation or updating of the composite score as shown in steps 46, 47, 48 and 49, with external visibility of the updated composite score as described above.

In an illustrative example, the PPRP process may be initiated by an evaluator at a client system by searching the first name and last name strings of a desired target within a server system. The server system checks for any identifying strings for the target. If matches are found, the server lists the potential targets to the evaluator. The evaluator then selects a single target, and proceeds to the evaluation process. In case a match is not found, the server system informs the evaluator, and provides the option for the evaluator to create a new profile entry for the desired target. When the evaluator selects a target to evaluate, the server system qualifies eligibility of the evaluator by requiring both 1) overlapping organizations and 2) overlapping tenures, with the target. See FIG. 1.

If the server system determines that the evaluator is eligible to evaluate the target, the server system permits the evaluator to continue the evaluation with a rating scale for several parameters, for example six parameters, along with a submit button. The rating scale captures the evaluators desired input of the target, for each parameter. In response to the selection of submit button, the client system captures the values from the rating scale and sends the values to the server system.

Upon receiving the values from the rating scale, the server system tags the values with the corresponding evaluator and target information and initiates a notification to the target user's email address and to the target user's profile through an html document. The notification informs the target user of the evaluator's name, but not the evaluator's ratings. See FIG. 1, step 8.

The evaluation notification consists of two possible actions: 1) accept or 2) archive, one of which is required to be selected by the target user.

Upon selecting ‘accept’ from the evaluation notification, as shown in FIG. 3a, the client system informs the server system, which, upon reaching the requisite, predetermined number of evaluation scores to reach the batch threshold, then inputs the rating scale values from the current batch of accepted evaluations, into an algorithm which further derives a composite score based on individual parameter ratings, including ratings received from other evaluators. Once the algorithm determines the updated composite score for the corresponding target user, the server system updates the composite score within its database, and publishes that composite score to the client system which further updates the composite score in the html document that is presented to the target user. If the predetermined number of evaluation scores required to reach the batch threshold is not met, the composite score may remain unchanged until the batch threshold is met and a recalculation is executed. Alternatively, the recalculation may occur with each received evaluation score but remain hidden or not visible externally until the batch threshold is reached.

As in FIG. 3b, upon selecting ‘archive’ from the evaluation notification, the client system informs the server system, which in this case, does not input the corresponding rating scale value into the algorithm. Instead the server system converts the ‘archive’ selection into a singular quantitative value which, when input into the algorithm, negatively affects the composite score. Again, the server system publishes this composite score to the client system, which further updates the html document that is presented to the target user.

Although various preferred embodiments have been described with reference to the Figures, other embodiments are possible.

For example, an embodiment containing a ‘hidden running score’ feature, where the PPRP system calculates a ‘running score’ after each accepted evaluation, however the running score is not published to the composite score until the number of accepted evaluations reaches the batch threshold. This is in contrast to the above illustrated examples, where the calculation is done on the composite score, after the batch threshold is met.

In another exemplary embodiment, the target user may be forced to accept or archive evaluations chronologically such that the target user cannot accept the next evaluation until action is taken on the previous evaluation, advantageously discouraging the target from hiding an evaluation by taking no action. In another exemplary embodiment, the PPRP may automatically accept evaluations not acted upon when the target user signs out, again, advantageously discouraging the target from hiding an evaluation by taking no action.

In another exemplary embodiment, evaluators that have previously submitted an evaluation on a peer/target, may not be permitted to change the evaluation or perform multiple evaluations on the same peer. In another similar embodiment, evaluators may be permitted to perform multiple evaluations on the same peer, under certain special conditions, for example, when peers have worked together in multiple organizations, when peers have worked together in the same organization for multiple tenures, or when a previous evaluation has aged passed some pre-determined threshold.

In another exemplary embodiment, various target email addresses from several evaluators, evaluating the same target, may be advantageously combined by the target, by email account integration. The target in this case, for example, may be permitted to verify several email addresses and combine them into one PPRP account.

In another exemplary embodiment, recruiters may advantageously be permitted to view a target user's composite score, regardless of the activation of the target user's profile. In the case where the target user has a non-activated account, for example, all evaluations performed on the target may be combined into a composite score, as if they were accepted by the target user.

In another exemplary embodiment, the evaluations may be saved with a ‘date of completion’ value. The value may be advantageously used to provide an expiration such that older evaluations are either not used in the composite score or weighted inversely proportional to its age, for example.

In another exemplary embodiment, the PPRP may advantageously recognize multiple ways of denoting a company, for example commonly used abbreviations, historical company names and subsidiaries.

In a final exemplary embodiment, the PPRP may provide an upgrade option and accept payment to become, for example, a power user. Power users may have the added authorization to see other users' composite scores, for example. The ability for power users to see others' composite score may be limited to those other users' explicit on-line consent to the on-line request from the power users.

The present invention should not be considered limited to the particular examples described above, but rather should be understood to cover all aspects of the invention. Various modifications, equivalent processes, as well as numerous structures to which the present invention may be applicable will be readily apparent to those of skill in the art to which the present invention is directed upon review of the present specification.

What is claimed is:

1. A method for generating web-based, peer-to-peer reviews of target users by evaluators, comprising:
searching a database for a target user name;
determining if the located target user is eligible for review by the evaluator;
initiation, completion and submission of the review of the target user by the evaluator;
calculating an individual review score for the valid and submitted review initiating an email to the target user alerting the target user of the submitted review;
determining by the target user whether to accept the review or to archive the submitted review; and
not allowing the target user to reject the submitted review.

2. The method of claim 1, further comprising invalidating the submitted review if the evaluator and the target user did not work at the same organization during overlapping time frames.

3. The method of claim 1, further comprising:
establishing a predetermined number of created review scores required to meet a batch threshold;
calculating a composite score for the individual scores; and
displaying an updated composite score to a user only when the batch threshold is met.

4. The method of claim 3, further comprising recalculating the composite score after each accepted review.

5. The method of claim 4, further comprising recalculating the composite score after each archived review.

6. The method of claim 5, wherein each archived review results in a negative impact on the composite score.

7. The method of claim 6, further comprising:
calculating a ratio of the number of archived reviews divided by the number of accepted reviews;
establishing a penalty factor;
establishing a penalty multiplier threshold;
establishing a penalty multiplier; and
comparing the calculated ratio to the established penalty multiplier threshold;
determining if the calculated ratio exceeds the established penalty multiplier threshold.

8. The method of claim 7, further comprising multiplying the calculated ratio by the established penalty factor if the calculated ratio does not exceed the established penalty multiplier threshold.

9. The method of claim 7, further comprising:
determining the calculated ratio exceeds the established penalty multiplier threshold;
subtracting the established penalty multiplier threshold from the calculated ratio and multiplying the resulting difference by the established penalty multiplier to calculate an amplification factor;
multiplying the amplification factor by the calculated ratio and by the penalty factor to calculate a negative impact factor for archived reviews.

10. The method of claim 9, wherein the established penalty factor is 0.05, the established penalty multiplier threshold is 0.5, and the penalty multiplier is 40.

11. The method of claim 1, further comprising:
creating an individual score for each submitted valid review;
establishing a predetermined number of created review scores required to meet a batch threshold;
calculating a composite score for the individual scores only when the batch threshold is met.

12. The method of claim 11, further comprising recalculating the composite score after each archived review.

13. The method of claim 12, further comprising showing the composite score to a user only when the composite score is calculated.

14. The method of claim 6, further comprising allowing the target user to reclassify an archived review as non-archived and recalculating the composite score.

15. The method of claim 14, further comprising allowing the target user to reclassify an archived review as non-archived and recalculating the composite score.

16. The method of claim 1, further comprising allowing an evaluator to create a proxy profile for a target user name that is not located in the database and allowing the evaluator to create and submit a review on the target user's proxy profile.

17. The method of claim 15, further comprising alerting the target user of the created proxy profile.

18. The method of claim 17, further comprising the target user activating the proxy profile.

19. The method of claim 18, further comprising invalidating the review if the evaluator and the target user did not work at the same organization during overlapping time frames.

20. The method of claim 1, further comprising preventing the target user to determine the effect of the review on an overall composite score.
